(19) United States
(12) Patent Application Publication
(10) Pub. No.: US 2019/0322574 A1
(43) Pub. Date: Oct. 24, 2019

(54) ANTISCRATCH AND ANTIWEAR GLASS

(71) Applicant: GUARDIAN GLASS, LLC, AUBURN HILLS, MI (US)

(72) Inventor: Liang Liang, Taylor, MI (US)

(73) Assignee: GUARDIAN GLASS, LLC, AUBURN HILLS, MI (US)

(21) Appl. No.: 16/388,575

(22) Filed: Apr. 18, 2019

Related U.S. Application Data
(60) Provisional application No. 62/659,989, filed on Apr. 19, 2018.

(51) Int. Cl. C03C 17/00; C03C 17/28

(52) U.S. Cl. CPC C03C 17/006; C03C 2218/113; C03C 2218/116; C03C 17/28

(57) ABSTRACT

A coated glass substrate is disclosed as well as a method of making the coated glass substrate. The coated glass substrate contains a glass substrate and a coating containing a hybrid network comprising at least two oxides. The coating exhibits a coefficient of friction of less than 0. 12 when measured according to ASTM D7027. The coating exhibits a critical scratch load of at least about 10 kg as measured according to ASTM test C1624-05.

### CROSS-REFERENCE TO RELATED APPLICATION

The present application claims filing benefit of U. S. Provisional Patent Application Ser. No. 62/659,989 having a filing date of Apr. 19, 2018, and which is incorporated herein by reference in its entirety

### BACKGROUND

Glass has many desired uses, particularly due to its transparent qualities. For many applications, such as display windows, decorative surfaces, and even glass touchscreens for electronic devices, it is desirable to have a hard coating layer on the glass to protect from marking or scratching. However, hard coatings may negatively affect the visual properties of the glass, may be expensive, and may require time consuming processes. Various types of coatings, such as diamond like coatings, have been employed to solve these problems. Diamond like carbon (“DLC”) coatings, however, require complicated equipment and long production times and have also been found to negatively affect the optical properties. To date, sol-gel coatings, while having a short production time and allowing for control over the sol-gel composition and thickness of the coating, have thus far failed to produce coated glass with excellent antiwear and/or antiscratch properties and good optical performance.

Therefore, it would be advantageous to form a coating utilizing sol-gel processes with excellent hardness characteristics, such as antiscratch and/or antiwear properties. It would also be desirable to form such a sol-gel coating that exhibits excellent optical properties.

### SUMMARY

In general, one embodiment of the present disclosure is directed to a coated glass substrate that comprises a glass substrate and a coating containing a hybrid network comprising at least two oxides. The coating exhibits a coefficient of friction of less than 0. 12 when measured according to ASTM D7027. Additionally, the coating exhibits a critical scratch load of at least about 10 kg as measured according to ASTM test C1624-05.

In general, another embodiment of the present disclosure is directed to a method of making a coated glass substrate. The method may include coating a glass substrate with a coating composition comprising a solvent and a plurality of hydrolyzed compounds to form a hybrid network comprising at least two oxides, and then thermally processing the coating and the glass substrate. The coating exhibits a coefficient of friction of less than 0. 12 when measured according to ASTM D7027. The coating exhibits a critical scratch load of at least about 10 kg as measured according to ASTM test C1624-05.

### BRIEF DESCRIPTION OF THE DRAWINGS

The invention will now be described, by way of example, with reference to the accompanying drawings, in which:

FIGS. 1 A and 1B are a view of an X-ray photoelectron spectrum of an example of a coating layer according to the present disclosure.

FIG. 2 is a view of a flow diagram for forming a coated glass substrate according to the present disclosure;

FIG. 3 is a chart showing thickness and refractive index as a function of spin speed of an example of a coating layer according to the present disclosure;

FIG. 4 is a chart showing percent transparency of glass, DLC coated glass, and an example according to the present disclosure;

FIG. 5 is a chart showing percent reflectivity of glass, DLC coated glass, and an example according to the present disclosure;

FIG. 6 is a chart showing thermogravimetric analysis (black) and differential thermal analysis (grey) curves at increasing temperatures of an example of a coating layer according to the present disclosure;

FIG. 7 shows optical microscopy results of antiscratch resistance for glass, DLC coated glass, and an example according to the present disclosure;

FIGS. 8A and 8B show the percent transparency and reflectivity of raw glass and an example according to the present disclosure;

FIGS. 9A and 9B show the wear cycle and antiscratch performance as a function of aging of an example according to the present disclosure;

FIGS. 10A and 10B demonstrate the hydrolysis and condensation of a silicon alkoxide, in particular tetraethylorthosilicate;

FIGS. 11A-11D demonstrate the hydrolysis and condensation of a titanium alkoxide, in particular titanium isopropoxide;

FIGS. 12A and 12B demonstrate the hydrolysis and condensation of an aluminum alkoxide, in particular aluminum butoxide;

FIGS. 13A and 13B demonstrate the hydrolysis and condensation of acetates, in particular zinc acetate and copper acetate, respectively; and

FIG. 14 demonstrates the formation of a hybrid network or complex from a plurality of hydrolyzed compounds.

### DETAILED DESCRIPTION

### Definitions

It is to be understood that the terminology used herein is for the purpose of describing particular embodiments only and is not intended to limit the scope of the present invention.

“Alkyl” refers to a monovalent saturated aliphatic hydrocarbyl group, such as those having from 1 to 25 carbon atoms and, in some embodiments, from 1 to 12 carbon atoms. “C_{x-y}alkyl” refers to alkyl groups having from x to y carbon atoms. This term includes, by way of example, linear and branched hydrocarbyl groups such as methyl (CH₃), ethyl (CH₃CH₂), n-propyl (CH₃CH₂CH₂), isopropyl ((CH₃)₂CH), n-butyl (CH₃CH₂CH₂CH₂), isobutyl ((CH₃)₂CHCH₂), sec-butyl ((CH₃)(CH₃CH₂)CH), t-butyl ((CH₃)₃O), n-pentyl (CH₃CH₂CH₂CH₂CH₂), neopentyl ((CH₃)₃CCH₂), hexyl (CH₃(CH₂CH₂CH₂)₅), etc.

It should be understood that the aforementioned definitions encompass unsubstituted groups, as well as groups substituted with one or more other groups as is known in the art. For example, an alkyl group may be substituted with from 1 to 8, in some embodiments from 1 to 5, in some embodiments from 1 to 3, and in some embodiments, from 1 to 2 substituents selected from alkyl, alkenyl, alkynyl, alkoxy, acyl, acylamino, acyloxy, amino, quaternary amino, amide, imino, amidino, aminocarbonylamino, amidinocarbonylamino, aminothiocarbonyl, aminocarbonylamino, aminothiocarbonylamino, aminocarbonyloxy, aminosulfonyl, aminosulfonyloxy, aminosulfonylamino, aryl, aryloxy, arylthio, azido, carboxyl, carboxyl ester, (carboxyl ester)amino, (carboxyl ester)oxy, cyano, cycloalkyl, cycloalkyloxy, cycloalkylthio, epoxy, guanidino, halo, haloalkyl, haloalkoxy, hydroxy, hydroxyamino, alkoxyamino, hydrazino, heteroaryl, heteroaryloxy, heteroarylthio, heterocyclyl, heterocyclyloxy, heterocyclylthio, nitro, oxo, oxy, thione, phosphate, phosphonate, phosphinate, phosphonamidate, phosphorodiamidate, phosphoramidate monoester, cyclic phosphoramidate, cyclic phosphorodiamidate, phosphoramidate diester, sulfate, sulfonate, sulfonyl, substituted sulfonyl, sulfonyloxy, thioacyl, thiocyanate, thiol, alkylthio, etc. , as well as combinations of such substituents.

### Detailed Description

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

In general, the present disclosure is directed to antiscratch and/or antiwear coated glass substrates that may also have a high degree of transparency and/or low reflective properties. The coated glass substrate may generally include a glass substrate with a coating that includes a plurality of oxides. For instance, a combination of a plurality of metal and/or non-metal oxides may be used to form the coating. In this regard, the coating may include a hybrid network of metal and/or non-metal oxides as further defined herein.

The present inventors have discovered that the coatings disclosed herein provide the substrates with improved antiscratch and/or antiwear properties and may also provide improved antimicrobial properties, improved optical properties, and/or improved durability. In particular, the present inventors have discovered that such antiscratch and/or antiwear properties can be improved in comparison to other conventional coatings, such as DLC coated glass. The present inventors have discovered that the coatings disclosed herein may contain crystals, such as microcrystals and/or nanocrystals, that allow for the enhanced properties. In particular, the present inventors have unexpectedly discovered that the amount and size of any crystals formed may be increased with increased age time of the coatings prior to tempering.

Additionally, without intending to be bound by theory, the present inventors have found that the crystallization in the coating may lead to a low coefficient of friction, which may contribute to the excellent antiscratch and/or antiwear properties. In general, coefficient of friction COF can be written as

COF=Fₓ/Fₙ

where Fₓ and Fₙ is the force applied on the surface at a horizontal and vertical direction. It was found that surfaces with a low COF could result in a striking objection sliding or slipping along the outer surface of the coating instead of the object destroying the surface of the coating and/or substrate. The COF of a coated glass substrate according to the present disclosure may exhibit a coefficient of friction that is at least about 10% less than the coefficient of friction of uncoated glass or DLC coated glass, such as at least about 20% less, such as at least about 30% less, such as at least about 40% less, such as at least about 50% less than the coefficient of friction of uncoated glass or DLC coated glass. Particularly, an embodiment of the present disclosure may have a coefficient of friction that is less than 0. 12, such as about 0. 11 or less, such as about 0. 10 or less, such as about 0. 09 or less, such as about 0. 08 or less, such as about 0. 07 or less, such as about 0. 06 or less. The coefficient of friction may be more than 0, such as about 0. 01 or more, such as about 0. 02 or more, such as about 0. 03 or more, such as about 0. 04 or more,.

The coatings of the present invention may also exhibit high durability and/or mechanical integrity. For example, a coated glass substrate according to the present disclosure may exhibit a critical scratch load, measured according to ASTM test C1624-05, of about 10 kg or more, such as about 11 kg or more, such as about 12 kg or more, such as about 13 kg or more, such as about 14 kg or more, such as about 15 kg or more. The critical scratch load may be about 30 kg or less, such as about 25 kg or less, such as about 23 kg or less, such as about 21 kg or less, such as about 20 kg or less, such as about 18 kg or less. Additionally, a coated glass substrate according to the present disclosure may have a critical scratch load that is at least about 10% greater than the critical scratch load of uncoated glass or DLC coated glass, such as at least about 20% greater, such as at least about 30% greater, such as at least about 40% greater, such as at least about 50% greater than the critical scratch load of uncoated glass or DLC coated glass.

Aging of the coating (e. g. , prior to tempering) may also attribute to improved mechanical performance of the coating and the coated glass substrate. For instance, coated glass substrates according to the present disclosure that have been aged for at least about 6 days may exhibit at least about a 50% increase, such as at least about a 100% increase, such as at least about a 200% increase in wear cycles in comparison to a coated glass substrate that has not been aged. Meanwhile, coated glass substrates aged for at least about 10 days may exhibit at least about a 500% increase, such as about at least about a 600% increase, such as at least about a 700% increase in wear cycles in comparison to a coated glass substrate that has not been aged. Further, coated glass substrates aged for at least about 14 days may exhibit at least about a 800% increase, such as about at least about a 900% increase, such as at least about a 1,000% increase in wear cycles in comparison to a coated glass substrate that has not been aged. Similarly, a coated glass substrate according to the present disclosure may exhibit an increase in critical scratch load of at least about 20%, such as at least about 30%, such as at least about 40% when aged for at least 7 days as compared to a coated glass substrate that has not been aged.

Furthermore, the coatings may allow the coated glass substrates according to the present disclosure to also exhibit improved optical properties, as measured by a spectrophotometer, that are similar to and/or even better than the optical properties of uncoated glass and/or DLC coated glass. For instance, the coated glass substrates of the present disclosure may have a percent transparency and/or percent reflection that is only slightly decreased from uncoated glass. Additionally, the coated glass substrates according to the present disclosure may have a percent transparency and percent reflection that is significantly better than DLC coated glass. Particularly, a coated glass substrate according to the present disclosure may have a percent transparency of about 75% or more, such as about 78% or more, such as about 80% or more, such as about 82. 5% or more, such as about 85% or more, such as about 90% or more when measured at a 550 nm wavelength. The percent transparency of the coated glass substrate may be less than 100%, such as about 98% or less, such as about 95% or less, such as about 94% or less, such as about 92% or less. Moreover, a coated glass substrate according to the present disclosure may exhibit a percent transparency that is at least about 10% greater than DLC coated glass, such as at least about 12. 5% greater, such as at least about 15% greater, such as at least about 17. 5% greater, such as at least about 20% greater than DLC coated glass. The coated glass substrate may exhibit a percent transparency that is about 40% or less, such as about 35% or less, such as about 30% or less, such as about 25% or less, such as about 20% or less than the percent transparency of DLC coated glass. Additionally, the percent transparency of the coated glass may be within about 10%, such as within about 5%, such as within about 2%, such as within about 1% of the percent transparency of uncoated glass. Such differences in percent transparency may be at a particular wavelength (e. g. , 550 nm) or over a range of wavelengths, such as from 500 nm to 900 nm, such as from 500 nm to 800 nm, such as from 500 nm to 700 nm, such as from 500 nm to 600 nm.

Similarly, a coated glass substrate according to the present disclosure may have a percent reflectivity that is about 20% or less, such as about 15% or less, such as about 12% or less, such as about 10% or less, such as about 8% or less when measured at a 550 nm wavelength. The percent reflectivity may be greater than 0%, such as about 3% or more, such as about 4% or more, such as about 5% or more, such as about 6% or more. Moreover, a coated glass substrate according to the present disclosure may have a percent reflectivity that is at least about 20% less, such as at least about 30% less, such as at least about 40% less, such as at least about 50% less than the percent reflectivity of DLC coated glass. Such differences in percent reflectivity may be at a particular wavelength (e. g. , 550 nm) or over a range of wavelengths, such as from 500 nm to 900 nm, such as from 500 nm to 800 nm, such as from 500 nm to 700 nm, such as from 500 nm to 600 nm.

In addition, by employing the coating as disclosed herein, the desired coating properties can be obtained. For instance, certain alkoxides and/or oxides can be selected to impart various properties/characteristics into the coating. For instance, utilizing copper may lead to a coating with a lower coefficient of friction and improved antiwear properties. Further, zirconium and titanium may impart greater crystal forming capabilities and hardness. Meanwhile, aluminum may aid in chemical stability. Additionally, silicon may aid in film formation and mechanical strength. That is not to say that the enumerated metals and/or non-metals do not have additional properties or may not cross into other beneficial categories, or alternatively, that any or all of the alkoxides and/or oxides containing the aforementioned metals and/or non-metals may be used in the same coating. Particularly, a coating formed according to the present disclosure, regardless of the exact alkoxides and/or oxides and amounts selected, may generally have a lower coefficient of friction, increased crystallinity, increased antiwear properties, increased antiwear properties, excellent optical properties, or any combination of the above benefits as compared to other conventional coatings, such as DLC coatings.

A. Glass Substrate

The glass substrate typically has a thickness of from about 0. 1 to about 15 millimeters, in some embodiments from about 0. 5 to about 10 millimeters, and in some embodiments, from about 1 to about 8 millimeters. The glass substrate may be formed by any suitable process, such as by a float process, fusion, down-draw, roll-out, etc. Regardless, the substrate is formed from a glass composition having a glass transition temperature that is typically from about 500° C. to about 700° C. The composition, for instance, may contain silica (SiO₂), one or more alkaline earth metal oxides (e. g. , magnesium oxide (MgO), calcium oxide (CaO), barium oxide (BaO), and strontium oxide (SrO)), and one or more alkali metal oxides (e. g. , sodium oxide (Na₂O), lithium oxide (Li₂O), and potassium oxide (K₂O)).

SiO₂ typically constitutes from about 55 mol. % to about 85 mol. %, in some embodiments from about 60 mol. % to about 80 mol. %, and in some embodiments, from about 65 mol. % to about 75 mol. % of the composition. Alkaline earth metal oxides may likewise constitute from about 5 mol. % to about 25 mol. %, in some embodiments from about 10 mol. % to about 20 mol. %, and in some embodiments, from about 12 mol. % to about 18 mol. % of the composition. In particular embodiments, MgO may constitute from about 0. 5 mol. % to about 10 mol. %, in some embodiments from about 1 mol. % to about 8 mol. %, and in some embodiments, from about 3 mol. % to about 6 mol. % of the composition, while CaO may constitute from about 1 mol. % to about 18 mol. %, in some embodiments from about 2 mol. % to about 15 mol. %, and in some embodiments, from about 6 mol. % to about 14 mol. % of the composition. Alkali metal oxides may constitute from about 5 mol. % to about 25 mol. %, in some embodiments from about 10 mol. % to about 20 mol. %, and in some embodiments, from about 12 mol. % to about 18 mol. % of the composition. In particular embodiments, Na₂O may constitute from about 1 mol. % to about 20 mol. %, in some embodiments from about 5 mol. % to about 18 mol. %, and in some embodiments, from about 8 mol. % to about 15 mol. % of the composition. Of course, other components may also be incorporated into the glass composition as is known to those skilled in the art. For instance, in certain embodiments, the composition may contain aluminum oxide (Al₂O₃). Typically, Al₂O₃ is employed in an amount such that the sum of the weight percentage of SiO₂ and Al₂O₃ does not exceed 85 mol. %. For example, Al₂O₃ may be employed in an amount from about 0. 01 mol. % to about 3 mol. %, in some embodiments from about 0. 02 mol. % to about 2. 5 mol. %, and in some embodiments, from about 0. 05 mol. % to about 2 mol. % of the composition. In other embodiments, the composition may also contain iron oxide (Fe2O₃), such as in an amount from about 0. 001 mol. % to about 8 mol. %, in some embodiments from about 0. 005 mol. % to about 7 mol. %, and in some embodiments, from about 0. 01 mol. % to about 6 mol. % of the composition. Still other suitable components that may be included in the composition may include, for instance, titanium dioxide (TiO₂), chromium (III) oxide (Cr₂O₃), zirconium dioxide (ZrO₂), ytrria (Y₂O₃), cesium dioxide (CeO₂), manganese dioxide (MnO₂), cobalt (II, III) oxide (Co₃O₄), metals (e. g. , Ni, Cr, V, Se, Au, Ag, Cd, etc. ), and so forth.

B. Coating

As indicated, a coating is provided on one or more surfaces of the substrate. For example, the glass substrate may contain first and second opposing surfaces, and the coating may thus be provided on the first surface of the substrate, the second surface of the substrate, or both. In one embodiment, for instance, the coating is provided on only the first surface. In such embodiments, the opposing second surface may be free of a coating or it may contain a different type of coating. Of course, in other embodiments, the coating of the present invention may be present on both the first and second surfaces of the glass substrate. In such embodiments, the nature of the coating on each surface may be the same or different.

Additionally, the coating may be employed such that it substantially covers (e. g. , 95% or more, such as 99% or more) the surface area of a surface of the glass substrate. However, it should be understood that the coating may also be applied to cover less than 95% of the surface area of a surface of the glass substrate. For instance, the coating may be applied on the glass substrate in a decorative manner.

In one embodiment of the present disclosure, the coating may be formed from a plurality of metal and/or non-metal alkoxides, a plurality of metal and/or non-metal oxides, or combinations thereof. For instance, such alkoxides and/or oxides may be employed to form a polymerized (or condensed) alkoxide and/or oxide coating via a reaction such as hydrolysis or condensation and subsequent removal of a solvent by heating or other means.

Generally, an alkoxide may have the following general formula

M^{x+}(OR)⁻ₓ

wherein,

x is from 1 to 4;

R is an alkyl or cycloalkyl; and

M is a metal or a non-metal cation.

While R, M, and x may be generally selected accordingly, in certain embodiments, they may be selected according to the following.

As indicated above, “x” may be from 1 to 4. However, “x” may be selected based upon the valence of the chosen metal or non-metal cation. As indicated above, “x” may be 1, 2, 3, or 4. In one embodiment, “x” is 1 while in other embodiments, “x” may be 2. In another embodiment, “x” may be 3 while in another embodiment “x” may be 4.

Similarly, “R” may be selected based upon the desired characteristics, including the desired stereospecificity of the resulting alkoxide. For instance, “R” may be an alkyl or cycloalkyl. In this regard, such alkyl may be C₁ or greater, such as a C₁-C₆. , such as a C₁-C₃, such as a C₂-C₃. Meanwhile, such cycloalkyl may be C₃ or greater, such as a C₃-C₆. , such as a C₄-C₆, such as a C₄-C₅. When “R” is an alkyl, “R” may be selected to be a methyl, ethyl, butyl, propyl, or isopropyl group. In one embodiment, “R” may be a propyl group, such as an isopropyl group. When R is a cycloalkyl, “R” may be a cyclopropyl, cyclobutyl, cyclopentyl, or cyclohexyl group.

As indicated above, “M” may be a metal cation or a non-metal cation. In one embodiment, “M” may be a metal cation. The metal may be a Group IA, IIA, IIIA, IVA, VA, VIA, IB, IIB IIIB, IVB, VB, VIB, VIIB, or VIIIB metal. For instance, “M”, while not necessarily limited to the following, may be aluminum, cobalt, copper, gallium, germanium, hafnium, iron, lanthanum, molybdenum, nickel, niobium, rhenium, scandium, silicon, sodium, tantalum, tin, titanium, tungsten, or zirconium. In one particular embodiment, “M” may be copper, aluminum, zinc, zirconium, silicon or titanium. In one embodiment, “M” may include any combination of the aforementioned. For instance, the alkoxide may include a combination of alkoxides including copper, aluminum, zinc, zirconium, silicon and titanium. In another embodiment, “M” may be a non-metal cation, such as a metalloid as generally known in the art.

In yet further embodiments, alkoxides may be selected according to the following exemplary embodiments. For example, exemplary alkoxides may include Cu(OR), Cu(OR)₂, Al(OR)₃, Zr(OR)₄, Si(OR)₄, Ti(OR)₄, and Zn(OR)₂, wherein R is a C₁ or greater alkyl group. For instance, the metal alkoxide may include, but is not limited to, aluminum butoxide, titanium isopropoxide, titanium propoxide, titanium butoxide, zirconium isopropoxide, zirconium propoxide, zirconium butoxide, zirconium ethoxide, tantalum ethoxide, tantalum butoxide, niobium ethoxide, niobium butoxide, tin t-butoxide, tungsten (VI) ethoxide, germanium, germanium isopropoxide, hexyltrimethoxylsilane, tetraethoxysilane, and so forth, and in a more particular embodiment may be titanium isopropoxide, zirconium n-propoxide, aluminum s-butoxide, copper propoxide, and/or tetraethoxysilane.

Generally, an oxide may have the following general formula

M_{b}Oₐ

wherein,

a is from 1 to 4;

b is from 1 to 4;

M is a metal or non-metal cation.

As indicated above, “a” may be from 1 to 4. However, “a” may be selected based upon the valence of the chosen metal or non-metal cation. As indicated above, “a” may be 1, 2, 3, or 4. In one embodiment, “a” is 1 while in other embodiments, “a” may be 2. In another embodiment, “a” may be 3 while in another embodiment “a” may be 4.

As indicated above, “b” may be from 1 to 4. However, “b” may be selected based upon the valence of the chosen metal or non-metal cation and “a”. As indicated above, “b” may be 1, 2, 3, or 4. In one embodiment, “b” is 1 while in other embodiments, “b” may be 2. In another embodiment, “b” may be 3 while in another embodiment “b” may be 4.

As indicated above, “M” may be a metal cation or a non-metal cation. In one embodiment, “M” may be a metal cation. The metal may be a Group IA, IIA, IIIA, IVA, VA, VIA, IB, IIB IIIB, IVB, VB, VIB, VIIB, or VIIIB metal. For instance, “M”, while not necessarily limited to the following, may be aluminum, cobalt, copper, gallium, germanium, hafnium, iron, lanthanum, molybdenum, nickel, niobium, rhenium, scandium, silicon, sodium, tantalum, tin, titanium, tungsten, or zirconium. In one particular embodiment, “M” may be copper, aluminum, silicon or titanium. In one embodiment, “M” may include any combination of the aforementioned. For instance, the oxide may include a combination of oxides including copper, aluminum, silicon and titanium. In another embodiment, “M” may be a non-metal cation, such as a metalloid as generally known in the art.

The coating disclosed herein may also be formed using other compounds. For instance, the alkoxides and/or oxides, in particular the oxides such as the polymerized oxides, may be formed from other compounds as well. These may include compounds such as a metal acetate. For instance, these may include zinc acetate, copper acetate, etc. , and combinations thereof.

In an additional embodiment, the coating may include at least one nanoparticle. For instance, the nanoparticle may be a metalloid containing nanoparticle, a metal containing nanoparticle, or a combination thereof. These particles include, but are not limited to, SiO₂, TiO₂, ZrO₂, Al₂O₃, ZnO, CdO, SrO, PbO, Bi₂O₃, CuO, Ag₂O, CeO₂, AuO, SnO₂, et.

The coating may contain at least one metalloid-containing nanoparticle. For instance, the nanoparticle may be a silicon-containing nanoparticle. That is, the nanoparticle may be a silica nanoparticle. Without intending to be limited by theory, the present inventors have discovered that the mechanical strength of the polymer network can be further enhanced by employing such silica nanoparticles. For instance, the silica particle may contain hydroxyl groups that can be condensed with the hydroxyl groups of a silane hydroxyl group of a silanol (e. g. , from a hydrolyzed organoalkoxysilane used to form the silicon-containing resin). In addition, the silica particles may also react with a carbocation in the polyol resins via a condensation reaction. In this regard, the silicon-containing nanoparticles may be discrete particles within the coating or may be bonded to a resin.

The silica may be crystalline silica or amorphous silica. In one embodiment, the silica may be amorphous silica. Amorphous silica may include silica gels, precipitated silica, fumed silica, and colloidal silica. In one embodiment, the silica may be colloidal silica. For instance, the silica nanoparticles may substantially contain (e. g. , 90 wt. % or more, such as 95 wt. % or more, such as 98 wt. % or more) of silicon dioxide.

In general, the silicon-containing nanoparticle may be one having a core with a silica surface. This includes nanoparticle cores that are substantially entirely silica, as well as nanoparticle cores comprising other inorganic (e. g. , metal oxide) or organic cores having a silica surface. In some embodiments, the core comprises a metal oxide. Any known metal oxide may be used. Exemplary metal oxides include silica, titania, alumina, zirconia, vanadia, chromia, antimony oxide, tin oxide, zinc oxide, ceria, and mixtures thereof. However, the core may also comprise a non-metal oxide.

The silicon-containing nanoparticle may include a surface treatment. In general, surface treatment agents for silica nanoparticles are organic species having a first functional group capable of covalently chemically attaching to the surface of a nanoparticle, wherein the attached surface treatment agent alters one or more properties of the nanoparticle. The surface treated nanoparticle may be reactive (i. e. , at least one of the surface treatment agents used to surface modify the nanoparticles may include a second functional group capable of reacting with one or more of the curable resin(s) and/or one or more of the reactive diluent(s) of the system).

Surface treatment agents often include more than one first functional group capable of attaching to the surface of a nanoparticle. For example, alkoxy groups are common first functional groups that are capable of reacting with free silanol groups on the surface of a silica nanoparticle forming a covalent bond between the surface treatment agent and the silica surface. Examples of surface treatment agents having multiple alkoxy groups include alkoxysilanes. For instance, these may include, but are not limited to trialkoxy alkylsilanes (e. g. , methyltrimethoxysilane, isooctyltrimethoxysilane, and octadecyltrimethoxysilane), and trialkoxy arylsilanes (e. g. , trimethoxy phenyl silane).

The silicon-containing nanoparticles may be provided in various forms, shapes, and sizes. The average size of the silicon-containing nanoparticles, such as the silica nanoparticles, is generally less than about 1 microns, such as about 500 nanometers or less, such as about 400 nanometers or less, such as about 300 nanometers or less, such as about 200 nanometers or less, such as about 100 nanometers or less to about 1 nanometer or more, such as about 2 nanometers or more, such as about 5 nanometers or more. As used herein, the average size of a nanoparticle refers to its average length, width, height, and/or diameter.

In one embodiment, the silicon-containing nanoparticles, such as the silica nanoparticles, may be elongated nanoparticles. For instance, the nanoparticles may have an average aspect ratio of more than 1, such as 2 or more, such as 3 or more, such as 5 or more to about 50 or less, such as about 30 or less, such as about 20 or less, such as about 15 or less, such as about 10 or less. For instance, the aspect ratio may be from greater than 1 to 50, such as from 2 to 25, such as from 3 to 15, such as from 5 to 10.

The silicon-containing nanoparticles, such as the silica nanoparticles, may have an average surface area of from about 50 square meters per gram (m²/g) to about 1000 m²/g, in some embodiments from about 100 m²/g to about 600 m²/g, and in some embodiments, from about 180 m²/g to about 240 m²/g. Surface area may be determined by the physical gas adsorption (B. E. T. ) method of Brunauer, Emmet, and Teller, Journal of American Chemical Society, Vol. 60, 1938, p. 309, with nitrogen as the adsorption gas.

If desired, the silicon-containing nanoparticles, such as the silica nanoparticles, may also be relatively nonporous or solid. That is, the nanoparticles may have a pore volume that is less than about 0. 5 milliliters per gram (ml/g), in some embodiments less than about 0. 4 milliliters per gram, in some embodiments less than about 0. 3 ml/g, and in some embodiments, from about 0. 2 ml/g to about 0. 3 ml/g.

Additionally, the ratio of the alkoxides and/or oxides to one another may be varied depending on the desired composition. However, generally, when a titanium based alkoxide and/or oxide is used, titanium may be present in the coating in an amount of about 10 wt. % or more, such as about 20 wt. % or more, such as about 25 wt. % or more such as about 30 wt. % or more to about 50 wt. % or less, such as about 40 wt. % or less, such as about 30 wt. % or less as determined according to XPS and the atomic%. Aluminum may be present in the coating in an amount of about 0. 5 wt. % or more, such as about 1 wt. % or more, such as about 3 wt. % or more, such as about 5 wt. % or more, such as about 7 wt. % or more, such as about 10 wt. % or more, such as about 13 wt. % or more, such as about 15 wt. % or more to about 30 wt. % or less, such as about 25 wt. % or less, such as about 20 wt. % or less, such as about 15 wt. % or less, such as about 10 wt. % or less, such as about 5 wt. % or less, such as about 3 wt. % or less as determined according to XPS and the atomic%. Silicon may be present in the coating in an amount of about 1 wt. % or more, such as about 3 wt. % or more, such as about 5 wt. % or more, such as about 8 wt. % or more, such as about 10 wt. % or more, such as about 15 wt. % or more to about 40 wt. % or less, such as about 30 wt. % or less, such as about 25 wt. % or less, such as about 20 wt. % or less, such as about 15 wt. % or less, such as about 10 wt. % or less as determined according to XPS and the atomic%. Copper may be present in the coating in an amount of about 0. 25 wt. % or more, such as about 0. 5 wt. % or more, such as about 1 wt. % or more, such as about 1. 5 wt. % or more, such as about 2 wt. % or more to about 10 wt. % or less, such as about 7 wt. % or less, such as about 5 wt. % or less, such as about 3 wt. % or less, such as about 2 wt. % or less as determined according to XPS and the atomic%. Zinc may be present in the coating in an amount of about 10 wt. % or more, such as about 20 wt. % or more, such as about 30 wt. % or more, such as about 40 wt. % or more, such as about 50 wt. % or more to about 70 wt. % or less, such as about 60 wt. %% or less, such as about 50 wt. % or less, such as about 40 wt. % or less as determined according to XPS and the atomic%. Zirconium may be present in the coating in an amount of about 10 wt. % or more, such as about 20 wt. % or more, such as about 30 wt. % or more, such as about 40 wt. % or more to about 70 wt. % or less, such as about 60 wt. % or less, such as about 50 wt. % or less, such as about 40 wt. % or less, such as about 30 wt. % or less as determined according to XPS and the atomic%.

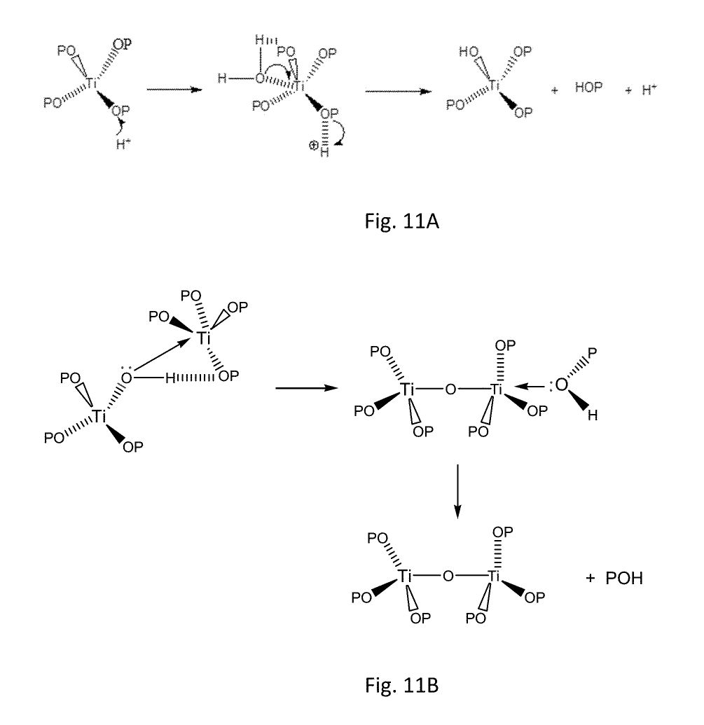

Furthermore, the metal and/or non-metal oxides may bond to form a hybrid network, such as a hybrid inorganic network, including any combination of the aforementioned oxides. For instance, the silicon alkoxide may be hydrolyzed and condensed to form a sol containing tetraethylorthosilicate. For instance, as shown in FIG. 10A, a silicon alkoxide (e. g. , tetraethylorthosilicate) can be hydrolyzed via an SN₂ mechanism. Thereafter, as shown in FIG. 10B, the hydrolyzed silicon alkoxide can be condensed thereby forming a network of two silicon alkoxide compounds. The condensation can be an alcohol condensation or a water condensation. As the silicon alkoxide is hydrolyzed and condensed, it can form a silicon oxide network. Such network may be linear, branched, or even cyclic. However, it should be understood that the other components may also be hydrolyzed and condensed.

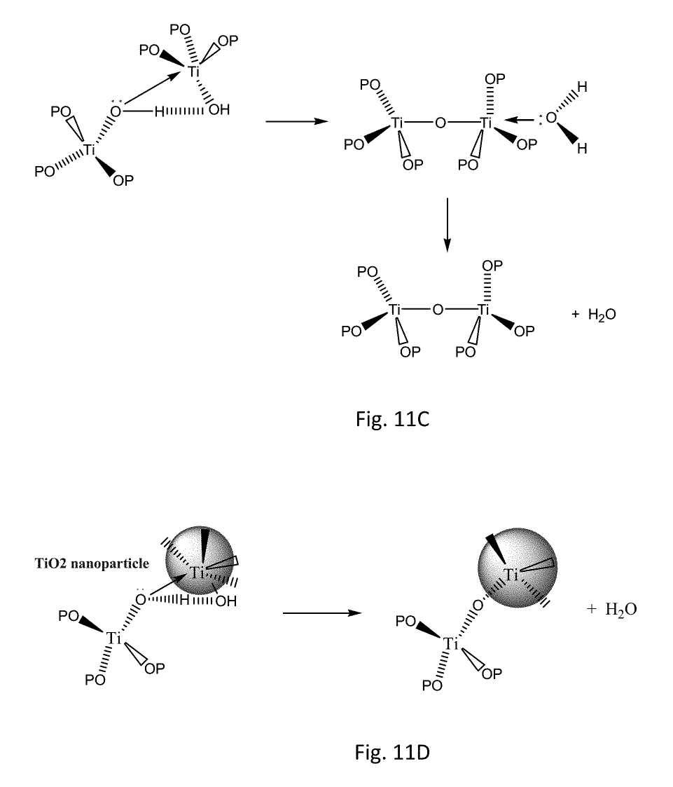

For instance, a titanium alkoxide (e. g. , titanium isopropoxide) as shown in FIG. 11A can be hydrolyzed. Without intending to be limited by theory, the isopropoxide group is activated by attacking of one proton which shifts the electron density and then a complex is generated by a water molecule. Thereafter, the hydrolyzed titanium alkoxide can be condensed by routine alkoxylation (FIG. 11B) or olation (FIG. 11C). Such condensation can result in a network containing titanium, in particular having Ti—O—Ti bonds (i. e. , a titanium oxide network). When present, as shown in FIG. 11D, the titanium alkoxide can also be bonded to a titanium dioxide nanoparticle.

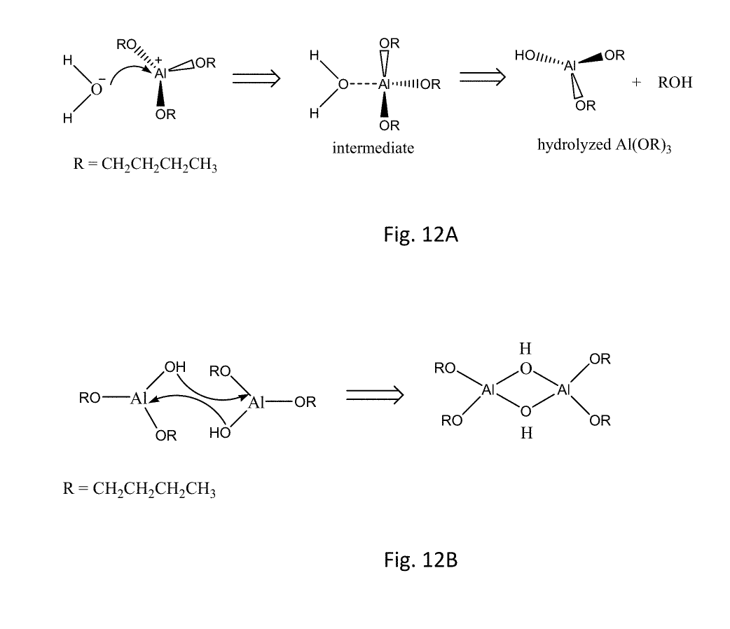

Furthermore, an aluminum alkoxide (e. g. , aluminum butoxide) can undergo hydrolysis as shown in FIG. 12A via an SN₂ mechanism. Thereafter, the hydrolyzed aluminum alkoxide may be condensed as shown in FIG. 12B. In particular, when condensed, a double oxygen bridge may form between the two aluminum atoms. Such condensation may result in the formation of Al—O—Al bonds (i. e. , an aluminum oxide network).

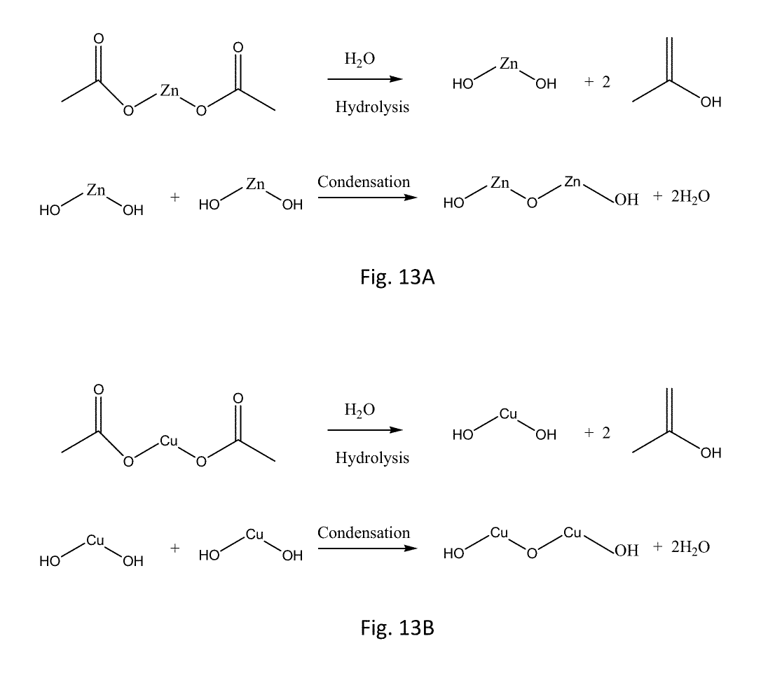

In addition, acetates may also be hydrolyzed and condensed. For instance, FIG. 13A demonstrates the hydrolysis and condensation of zinc acetate to form a network containing zinc, in particular having Zn—O—Zn bonds (i. e. , a zinc oxide network). Similarly, FIG. 13B demonstrates the hydrolysis and condensation of copper acetate to form a network containing copper, in particular having Cu—O—Cu bonds (i. e. , a copper oxide network).

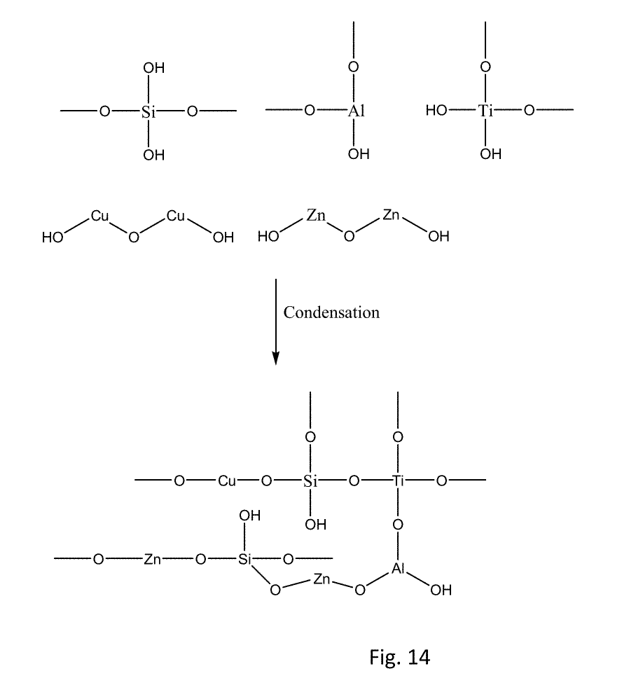

The individual hydrolyzed compounds (i. e. , metal and non-metal alkoxides and acetates) can be condensed to form a crosslinking/hybrid network containing a plurality of oxides, such as a plurality of metal and/or non-metal oxides. As shown in FIG. 14, the oxides can be condensed to form a hybrid network. FIG. 14 demonstrates a hybrid network formed from a hydrolyzed silicon alkoxide, a hydrolyzed aluminum alkoxide, a hydrolyzed titanium alkoxide, a hydrolyzed copper acetate, and a hydrolyzed zinc acetate to form a hybrid network or complex containing silicon oxide (i. e. , Si—O bonds), aluminum oxide (i. e. , Al—O bonds), titanium oxide (i. e. , Ti—O bonds), copper oxide (i. e. , Cu—O bonds), and zinc oxide (i. e. , Zn—O bonds). In such a structure, the Zn—O may play an antimicrobial function and also contribute to the antiwear properties. Also, the Cu—O, Ti—O, and Zn—O may contribute to the Antiscratch function. The Al—O may contribute to the anticorrosion function.

However, it should be understood that any combination of the aforementioned, including those generally mentioned above, may be combined to form a crosslinked or hybrid network/complex. In this regard, such hybrid network or complex can contain any number of the aforementioned metals and/or non-metals bonded via an oxygen atom.

As indicated herein, a plurality of compounds may be employed to form the coating. In one embodiment, at least about two, such as at least about three, such as at least about four, such as at least about five, such as six or more different metals and/or non-metals may be employed to form the coatings. That is, the aforementioned number of metal and/or non-metal compounds may be hydrolyzed and/or condensed to form the coating, such as the hybrid network/complex. In general, the coating may be formed from less than ten, such as less than 8, such as less than 7, such as less than 6, such as less than 5 of such compounds.

Another advantage to having such hydrolyzed compounds is the ability to form a tight bond with the glass substrate. For instance, the hydroxyl groups on the glass surface and those of the hydrolyzed compounds can react to form a tight bond for maintaining the coating on the glass substrate.

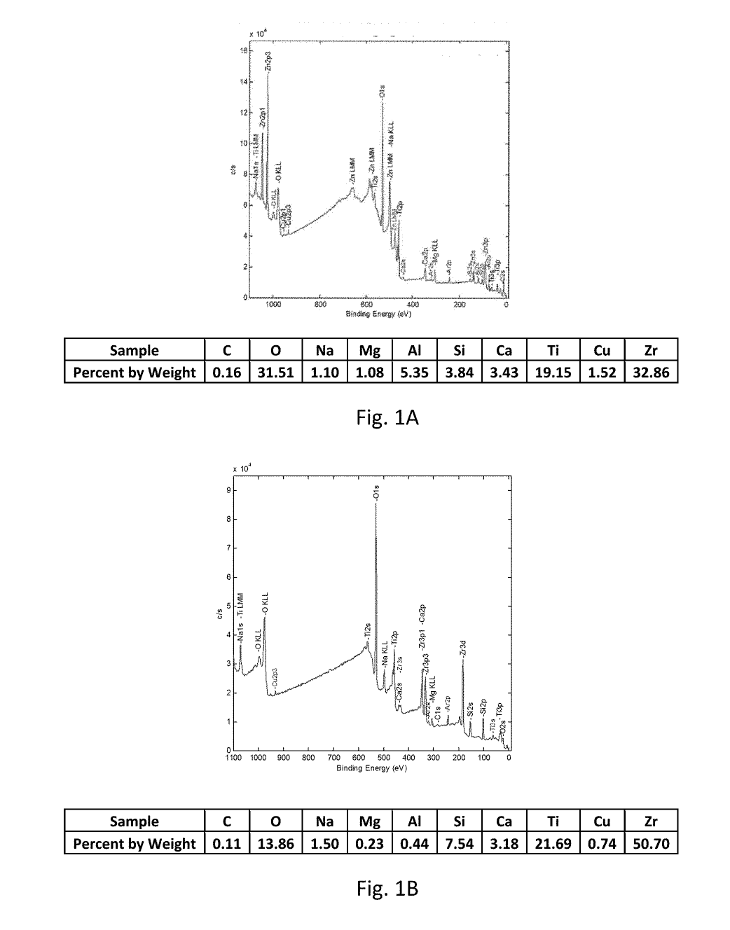

An exemplary composition of a coating according to the present disclosure may be generally shown by FIGS. 1A and 1B. However, while the coatings of FIG. 1A and 1B portray an exemplary coating that includes aluminum, silicon, titanium, copper, and zirconium alkoxides and/or oxides, a coating according to the present disclosure may include less or more alkoxides and/or oxides. As discussed in the present disclosure, various alkoxides and/or oxides may be selected for their excellent antiscratch and antiwear proper, while others may impart additional properties. Furthermore, any or all alkoxides and/or oxides used may contribute to the antiscratch or antiwear properties of the present disclosure and additional benefits may be an ancillary benefit, or alternatively, additional alkoxides and/or oxides may be selected that impart little to no antiscratch or antiwear properties to the coating, and instead are focused on additional benefits.

Regardless of the final composition of the coating, including the ratios used, the present inventors have unexpectedly discovered that the coating exhibits excellent antiwear and antiscratch properties even though the final coating may contain little to no part of carbon or carbon based components. Particularly, the present inventors have found that the lowered coefficient of friction exhibited by the present coating negates the previous held need for the lubricant-like effect of carbon-based coatings. Therefore, a coating of the present disclosure may have about 5 wt. % or less of carbon or carbon based compounds in the final coating, such as about 4 wt. % or less, such as about 3 wt. % or less, such as about 2 wt. % or less, such as about 1 wt. % or less, such as about 0. 5 wt. % or less of carbon or carbon based compounds in the final coating. In one embodiment, the final coating may be generally free of carbon based compounds. In general, such reference to carbon may be with respect to amorphous carbon.

A coating of the present disclosure may generally be formed by combining an alkoxide and/or oxide precursor selected according to the present disclosure with a solution. Generally speaking, while other coating processes known in the art may be used, the present disclosure may form a coating layer by a wet chemical method, such as a sol-gel process. While any known sol or solution may be used, in one embodiment, the sol may include an organic solvent, water, and/or one or more acids. In a further embodiment, the solution may also optionally include a surfactant as well as other components to form the desired alkoxide and/or oxide solution. For example, the solution may also include preservative compounds, surfactants, solubilizers, and the like as well as other known substituents in the art.

In one embodiment, the organic solvent may be of or include a low molecular weight alcohol such as n-propanol, isopropanol, ethanol, methanol, butanol, etc. However, in other embodiments, any organic solvent, including higher-molecular weight alcohols, may be used.

In a further embodiment, the solvent may also include an acid, such as an acid that may act as a catalyst for the sol-gel process. Particularly, in an embodiment, the acid may be an acid such as acetic acid or nitric acid. In a further embodiment, more than one acid may be used, and alternatively or additionally, may be used to maintain the alkoxides and/or oxides in solution e. g. aid in keeping the alkoxides and/or oxides from precipitating from the sol.

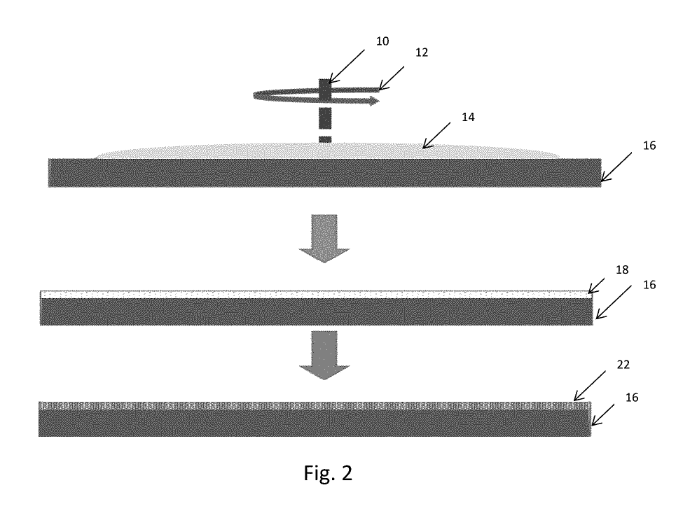

Conventional wet chemical methods to produce alkoxide and/or oxide coatings may use sol-gel processes involving hydrolysis and/or condensation reactions of the alkoxides and/or oxides, such as generally shown in FIG. 2. Particularly, a solution, shown generally by reference numeral 10, including one or more precursor alkoxides and/or oxides may be applied to a substrate via spin coating 12 in one embodiment, forming a precursor solution 14 on the substrate 16. After the spin coating has been completed, the precursor solution forms a thin film 18 on the substrate 16. As generally known in the art, the spin speed may be selected based upon the desired thickness of the final coating 22, particularly, the thickness of a final coating layer 22 is inversely proportional to the spin speed squared.

For example, coatings may be formed from spin speeds of about 800 rpm, such as up to about 1000 rpm, such as up to about 1200 rpm, such as up to about 1400 rpm, such as up to about 1600 rpm, such as up to about 1800 rpm, such as up to about 2000 rpm, such as up to about 2200 rpm, such as up to about 2400 rpm, such as up to about 2600 rpm, such as less than about 3000 rpm, such as less than about 2900 rpm, such as less than about 2800 rpm, such as less than about 2700 rpm, such as less than about 2600 rpm, such as less than about 2500 rpm, such as less than about 2400 rpm, such as less than about 2300 rpm, such as less than about 2200 rpm, such as less than about 2100 rpm, such as less than about 2000 rpm, such as less than about 1900 rpm, such as less than about 1800 rpm. Additionally, there are further benefits in applying the coating utilizing a sol-gel and/or spin coating, particularly, these processes may lead to a coating that is uniformly and evenly coated.

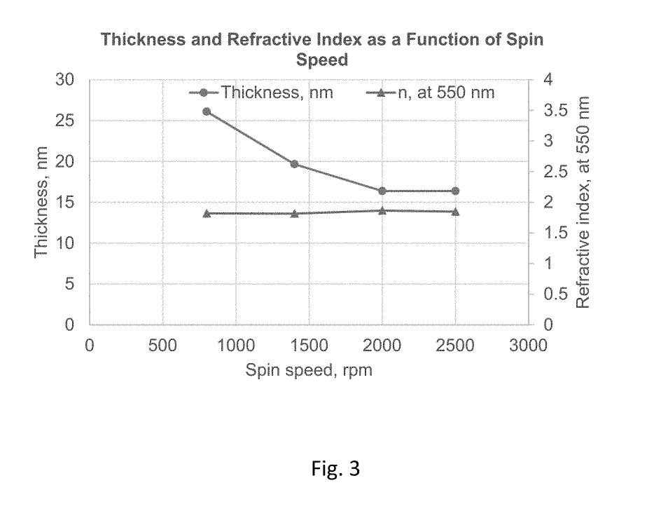

However, unlike previously used coatings, such as DLC coatings, the present inventors have unexpectedly found that a composition according to the present disclosure may form a coating wherein the final thickness of the coating has little to no impact on the refractive index, which is generally shown in FIG. 3. Thus, while coating thickness may be controlled based upon the spin speed upon application, the present inventors have found that coating thickness may be selected based upon desired coating properties, as increase or decrease in coating thickness has little to no impact on the refractive index of the coating or the coated glass. Therefore a final coating according to the present disclosure may have a thickness of at least about 20 nm, such as at least about 25 nm, such as at least about 30 nm, such as at least about 35 nm, such as at least about 50 nm, such as at least about 75 nm, such as at least about 100 nm, such as at least about 150 nm, such as at least about 200 nm, such as at least about 250 nm. The final coating may have a thickness of about 300 nm or less, such as about 250 nm or less, such as about 200 nm or less, such as about 150 nm or less, such as about 100 nm or less, such as about 50 nm or less, such as about 40 nm or less, such as about 30 nm or less.

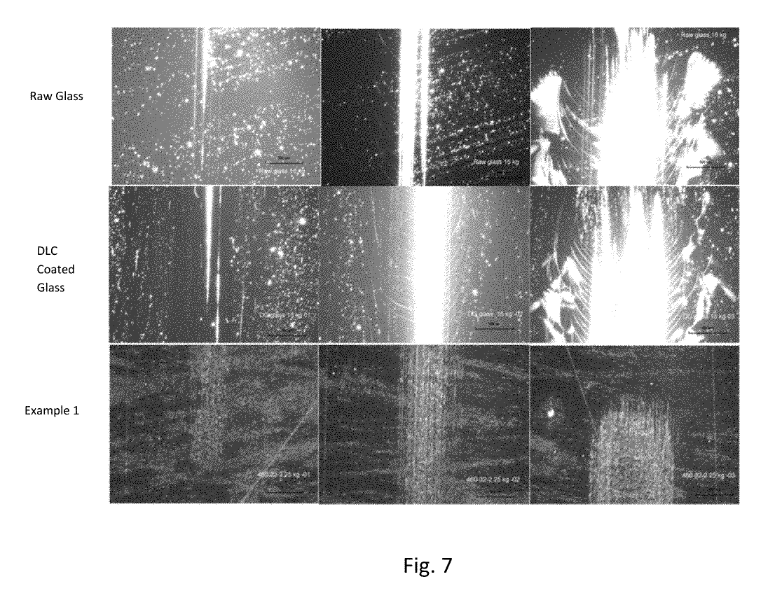

The present inventors have found that by thermal processing at a high temperature, the remaining solution may be evaporated and additionally, crystal formation may begin. Additionally, in some embodiments, by heating at high temperatures, solution that remains or is produced during crystallization may be removed from the coating, such as generally shown in FIG. 6 as described in Example 2 below.

Additionally, thermal processing or tempering may be performed for an amount of time generally known in the art. Particularly, a time and temperature may be selected such that the solution and undesired components are largely removed or evaporated from the final coating. For instance, in one embodiment, the substrate may be tempered for at least about 1 minute, such as at least about 2 minutes, such as at least about 3 minutes, such as at least about 4 minutes, such as at least about 5 minutes, such as at least about 7 minutes, such as at least about 9 minutes, such as at least about 10 minutes, such as less than about 30 minutes, such as less than about 25 minutes, such as less than about 20 minutes, such as less than about 15 minutes, such as less than about 12 minutes, such as less than about 10 minutes.

In addition, the thin film alkoxide and/or oxide coatings that are formed from these sols may be generally fired at elevated temperatures to convert the precursor compounds into the final alkoxide and/or oxide coatings. During thermal processing or tempering, heating profiles of gradual temperature ramp rates may be employed to burn off organic content and form oxide coatings or the coatings alternatively may be exposed to only a single high temperature. For example, in an embodiment of the present disclosure, the coating and substrate may undergo thermal processing at a high temperature such as about 425° C. or greater, such as about 450° C. or greater, such as about 500° C. or greater, such as about 550° C. or greater, such as about 600° C. or greater, such as about 650° C. or greater, such as about 700° C. or greater, such as about 800° C. or less, such as about 750° C. or less, such as about 700° C. or less, such as about 675° C. or less, such as about 650° C. or less.

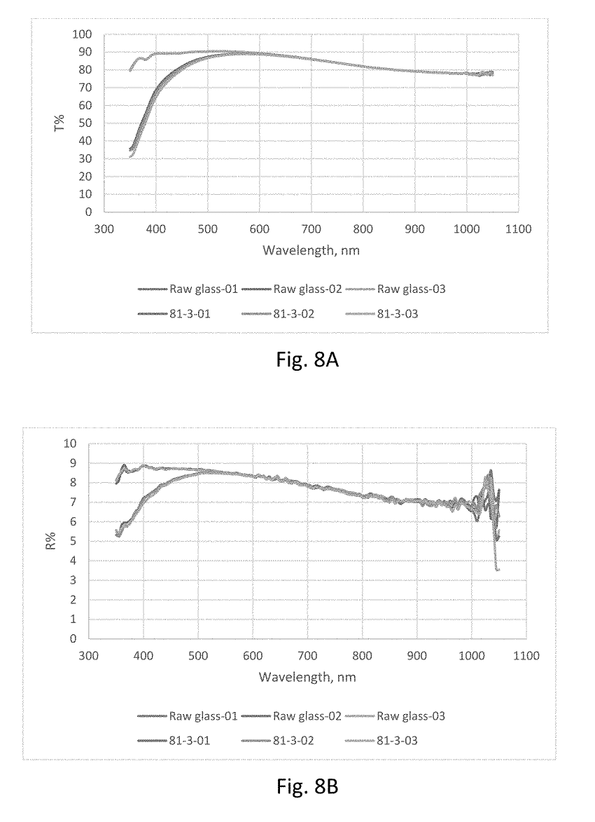

As shown in FIGS. 6 and 7, in addition to the improved antiwear and antiscratch properties exhibited by a coating of the present disclosure, both antiwear and antiscratch properties can be further improved with increased aging time as shown by the number of wear cycles and critical scratch load respectively. A coated glass substrate may be aged for several hours or several days, before or after tempering of the final glass, but after the initial thermal processing. Aging may aid in ensuring thorough hydrolysis of precursor alkoxides and/or oxides and may also allow the formation of a larger number and/or larger sized crystals in the coating. Aging of the coated glass substrate may occur at room temperature or may be conducted above or below room temperature. In one embodiment, the coated glass substrate may be aged for at least about one day, such as at least about two days, such as at least about four days, such as at least about five days, such as at least about seven days, such as at least about ten days, such as at least about twelve days, such as at least about fourteen days, such as about twenty-one days or less, such as about seventeen days or less, such as about fifteen days or less.

While embodiments of the present disclosure have been generally discussed, the present disclosure may be further understood by the following, non-limiting examples.

### EXAMPLES

### Test Methods

Scanning Electron Microscopy (SEM): The morphologies of the antiscratch glass were observed by Hitachi S4800 field emission SEM. The working distance was 4. 0 mm and 6. 7 mm for images of a top surface and a rotated position (45 degrees), respectively. A tungsten coated layer with a thickness of 5 to 10 nm was on the surface and the accelerating voltage was 5 kV.

Transparency and Reflectivity: Transparency (T%) and reflectivity (R%) were measured by Hunter UltraScan XE with model of TTRIN and RSIN, respectively. Y D65/10 was used as evaluation of T% and R%.

Antiscratch and/or Antiwear Resistance: The antiscratch and/or antiwear resistance was evaluated by Universal Machine Test (UMT) according to ASTM test C1624-05. Particularly, the examples of the present disclosure utilized a Micro-tribometer, UMT-02. A 3″×3″ glass sample was cleaned with isopropanol, dried by nitrogen gas, and then placed on a working stage. A diameter as 3 mm of aluminum ball was used to conduct the scratch test, and the loading force was increased from 1 kg to 15 kg with a 60 second loading time. The scratch tracks were then recorded using optical microscopy or scanning electron microscopy.

Optical Microscopy: Optical microscopy images were obtained using HAL 100, Axiotech from Zeiss.

XPS Measurements: XPS data was acquired with a PHI Quantum 2000 unit using a probe beam of focused, monochromatic Al Ka radiation (1486. 6 eV). The analysis area was 600 microns and the take-off angle and the acceptance angle were about 45° and +/−23°, respectively. The sputter rate was ˜100 Angstroms/minute (SiO₂ equivalent) and ion gun condition was Ar+ (2 keV, 2 mm by 2 mm raster). The atomic composition and chemistry of the sample surface is determined. The escape depth of the photoelectrons limits the depth of the analysis to the outer ˜50 Angstroms. The typical detection limits for most other elements is 0. 1 to 1 atomic%. The data presented includes general survey scans, which give the full spectrum between 0 and 1100 eV binding energy.

Coefficient of Friction: The coefficient of friction was determined in accordance to ASTM D7027 using a UMT-02 micro-tribometer, a loading force of 1 kg, a loading rate of 1 kg/minute, and a diameter as 10 mm of aluminum ball, in particular aluminum oxide ball.

Tape Pull: Tape pull test follows the testing procedure of TP-201-7 (Guardian Ind. ). The tape (3179C, 3M) is adhered on the surface of tempered glass by applying pressure. After 1. 5 minutes, the tape is pulled out quickly by hand and the residual adhesive of tape will be removed with tissue paper (AccuWipe) soaked by NPA. The damaged surface can be observed.

Stud Pull: Surface of “as coated” and tempered glass is blown by N₂ gas. Aluminum dolly (DeFelsko) with diameter as 20 mm is polished by sand paper. Premium (Loctite 736) is spared on surface of as coated and tempered glass and Al stud. After wafting 5 minutes, adhesive (Loctite 312) is added on surface of the Al stud and the Al stud is glued with surface of as coated or tempered glass with pressure until a solid adhesive is achieved. The glued Al stud and glass is set at room temperature for 3 hours. Then, the dolly is pulled by PosiTest AT (DeFelsko) with pull rate as 30 psi/sec. The adhesive strength is recorded by instrument and failure of stud pull test is adhesive strength less than 450 psi.

Crockmeter: Crockmeter test follows the testing procedure of TP-209 (Guardian Ind. ; Crockmeter: SDL Atlas CM-5). The size of the glass is 3″×3″ and total test cycle number is 750. The weight of the arm is 345 g. The change of the surface after testing will be divided by the scratch line on surface. The highest rank is 1, which indicates there is no scratch line left on the tested surface.

Brush Test: Glass with size of 2×3″ is mounted on a chamber filled with DI water and a brush with a size of 2×4″ is used to scratch the surface of as coated glass. The cycle number of brushes including back and forth motion is 6000. The surface of the glass is examined by microscopy after testing. No clear scratch on the film will be a sign of passing and ranks as 1. The change of T% will be calculated by the difference of T% before and after the brush test.

Cross-Hatch Test: The procedure of the cross-hatch tape pull test is as follows: One as coated glass (3×3″) is set on a sample holder and the coated layer is scratched with a metal blade on the horizontal and vertical direction, respectively. Then, tape 3179 is adhered on the cross scratched place and pulled out quickly. The residual paint on tape is observed and compared with standard pattern in order to identify the rank of damage.

NaOH Solution (0. 1N): NaOH test follows the testing procedure of TP301-7B (Guardian Ind. ). Glass is immersed by NaOH solution (0. 1 N) filled in one beaker at room temperature. After 24 hours, the glass is taken from solution, rinsed by De-ion water and dried by N2 gas. The change of T%, C, and E will be calculated by the difference of T%, L*, a* and b* before and after NaOH testing. Meanwhile, post cross-hatch and UMT is used to measure the strength of thin film.

HCI Solution (5%): HCI solution test follows the testing procedure of TP301-C (Guardian Ind. ). Glass is immersed by HCI solution (5%) filled in one beaker at room temperature. After 24 hours, the glass is taken from solution, rinsed by De-ion water and dried by N₂ gas. The change of T%, C, and E will be calculated by the difference of T%, L*, a* and b* before and after HCI solution testing. Meanwhile, post cross-hatch and UMT is used to measure the strength of thin film.

Mineral Oil: Mineral oil test follows the testing procedure of TP301-16C (Guardian Ind. ). Glass is immersed in mineral oil filled in one beaker at room temperature. After 24 hours, the glass is taken from solution, rinsed by De-ion water and dried by N₂ gas. The change of T%, C, and E will be calculated by the difference of T%, L*, a* and b* before and after solution testing. Meanwhile, post cross-hatch and UMT is used to measure the strength of thin film.

### Example 1

The samples in the following example were prepared by coating a glass substrate with a sol by spin coating.

Sols I-IV were prepared according to the formulations in Table 1 below.

TABLE 1

| | Sol I | Sol II | Sol III | Sol IV | Gen 1.5 |
|---|---|---|---|---|---|
| ID | (456-29-2) | (456-32-1E) | (456-37-2) | (456-100-2) | Sol (3%) |
| Titanium isopropoxide (g) | 2 | — | — | — | — |
| Zirconium n-propoxide (g) | — | — | 2 | — | — |
| Aluminum s-butoxide (g) | — | — | — | 2 | — |
| Copper acetate (g) | — | 1.5 | — | — | — |
| Tetraethyl orthosilicate (g) | — | — | — | — | 0.27 |
| Nanosilica particle (IPA-ST- | — | — | — | — | 0.22 |
| UP) (g) | | | | | |
| NPA (g) | 18 | 2 | 18 | 24 | 10.83 |
| De-ion water (g) | 0.1 | 12 | 0.2 | — | 0.14 |
| Acetic acid (g) | 0.1 | — | 0.2 | — | 0.37 |
| HNO₃ (70%) (g) | 1 | 2.4 | 2 | 2 | — |

Using the sols of Table 1, the following formulations of Table 2 were prepared by incorporating the sols in a mixture with a silane formulation.

TABLE 2

| | Sample 1 | Sample 2 | Sample 3 | Sample 4 |
|---|---|---|---|---|
| Chem. | (460-32-2) | (460-32-3) | (460-32-4) | (460-32-5) |
| Gen 1.5, 3% (g) | 0.5 | 0.5 | 0.5 | 0.5 |
| Sol I, TiO₂ (g) | 2 | 1 | 0.5 | 1 |
| Sol II, CuO (g) | 2 | 3 | 4 | 3 |
| Sol III, ZrO₂ (g) | 1 | 1 | 0.5 | 1 |
| Sol IV, Al₂O₃ (g) | 0.2 | 0.2 | 0.2 | 0 |
| Sol V, (SiO₂) (g) | 0.5 | 0.5 | 0.5 | 0.5 |

The solutions were applied to a glass substrate with a size of 3″×3″ and a thickness of 4 mm that had been cleaned using CeO₂ powder (1%) and soap, rinsed with DI water, and dried with N₂ gas. Next, 2 mL of sample were transferred to the surface of the glass substrate being spun at a speed of about 2000 rpm and the samples were spun for about 30 seconds. The wet coated glass was tempered at 650° C. for five minutes. The coated glass was washed after cooling to room temperature and tested.

Table 3 provides the coefficient of friction of Sample 1 as prepared according to Tables 1 and 2 and in comparison to uncoated glass and a DLC coated glass. Three samples were tested and the averages are presented in Table 3. As shown in Table 3, Sample 1 has a coefficient of friction, as tested based upon scratch resistance testing according to ASTM D7027 that is 50% lower than the coefficient of friction of either uncoated glass or DLC coated glass.

TABLE 3
Coefficient of Friction

| Glass | COF | STD |
|---|---|---|
| Uncoated glass, 4 mm | 0.12 | 0.03 |
| Sample 1 | 0.06 | 0.01 |
| DLC | 0.12 | 0.02 |

Table 4 provides critical scratch loading values with Sample 1 prepared according to Tables 1 and 2 and in comparison with uncoated glass and a DLC coated glass. Testing was performed using a Rockwell C diamond tip with a 100 μm radius of curvature, a loading force of 25 kg, and a sliding distance of 20 mm. Table 4 provides that the CSL of developed antiscratch glass is almost 50% greater than the CSL of DLC coated glass.

TABLE 4
Critical Scratch Loading

| ID | Scratch, mm | Un-scratch, mm | CSL, kg |
|---|---|---|---|
| Uncoated glass, 4 mm | 18 | 2 | 2.5 |
| DG 1.5, 8 mm | 13 | 7 | 8.75 |
| Sample 1, 4 mm | 6 | 14 | 17.5 |

FIG. 7 illustrates the scratch tracks of the samples in Table 4. As can be seen, the optical images of Sample 1 demonstrate less damage/scratching than the uncoated glass and the DLC coated glass. In FIG. 7, the first column illustrates an initial stage, the middle column illustrates an intermediate or development stage, and the third column illustrates a final stage. In general, the loading cycle applied during the scratch resistance test gives to three different regimes: micro-ductile regime corresponding to plastic deformation, micro-cracking regime corresponding to small chip formation, and the debris regime corresponding to the formation of debris. As illustrated in FIG. 7, all three regimes can be seen for the raw/uncoated glass and the DLC coated glass. However, for Sample 1, only plastic deformation was developed on the surface and no cracked chips or debris was observed.

The optical performance of the samples was measured and the results are as provided in Table 5.

TABLE 5
Optical Performance

| | | | | | | Coating | |
|---|---|---|---|---|---|---|---|
| | | | | | | Thickness | Refractive |
| | T % | R % | L* | a* | b* | (nm) | index |
| Raw glass, 4 mm | 89.89 | 8.47 | 95.94 | −0.86 | 0.23 | 0 | 1.5 |
| DLC glass, 8 mm | 71.4 | 24.05 | 87.71 | 0.18 | −0.88 | 1^{st}: DLC 5-7 nm | ~2.2 |
| | | | | | | 2^{nd}: SiNx 70 nm | |
| Sample 1, 4 mm | 87.35 | 10.48 | 94.89 | −0.91 | 1.44 | 246.3 | 1.67 |

Table 5 provides that the reflectivity of DLC coated glass is higher than raw/uncoated glass and the glass of Sample 1. In addition, there is only a slight reduction in the transparency of the glass of Sample 1 in comparison to raw/uncoated glass. However, there is a substantial increase in transparency of the glass of Sample 1 in comparison to DLC coated glass.

### Example 2

The samples in the following example were prepared by coating a glass substrate with a sol by spin coating.

The sol was prepared according to the formulation in Table 6 below.

TABLE 6

Sample 5
(460-83-6)

| Chem. | wt. (g) | wt. % |
|---|---|---|
| Titanium isopropoxide | 0.70 | 3.3 |
| Zirconium n-propoxide | 0.49 | 2.3 |
| Aluminum s-butoxide | 0.07 | 0.3 |
| Copper acetate | 0.53 | 2.4 |
| Tetraethyl orthosilicate | 0.05 | 0.2 |
| (TEOS) | | |
| Nano silicate (IPA-ST-UP) | 0.26 | 1.2 |
| Acetic acid | 0.15 | 0.7 |
| HNO3 (70%) | 1.75 | 8.2 |
| De-ion water | 4.32 | 20.1 |
| NPA | 13.20 | 61.3 |
| Total | 21.52 | 100.00 |

Table 7 provides the optical performance of Sample 5 prepared according to Table 6 in comparison with uncoated glass and a DLC coated glass. T% represents percent transparency and Rf% represents percent reflectivity wherein percent transparency and percent reflectivity are measured by spectrophotometer as discussed herein. Particularly, Table 7 shows that Sample 5 exhibits optical properties similar to uncoated glass and at least 10% greater than those exhibited by DLC coated glass.

TABLE 7
Optical Performance
Optical performance

| | | Sample 5 | | |
|---|---|---|---|---|
| Sample | Uncoated glass | (460-83-6) | Δ % | DLC coated, 8 mm |
| T % | 90.1 | 88.51 | −1.59 | 80.62 |
| Rf % | 8.46 | 9.79 | 1.33 | 9.89 |
| Rg % | 8.46 | 9.68 | 1.22 | 7.03 |
| Haze % | 0.09 | 0.17 | 0.08 | 0.30 |

In addition, Table 8 provides critical scratch loading values with sample 5 as prepared according to the Table 6. In addition, prior to tempering, certain samples were aged. Thus, Table 8 provides a comparison of the critical scratch loading for aged and unaged samples.

TABLE 8
Critical Scratch Loading

| | | | | | | | DLC |
|---|---|---|---|---|---|---|---|
| | Raw Glass | | | Sample 5 | | | Glass |
| Sample | No | 30 days | ΔCSL | No | 30 days | ΔCSL | No |
| CSL | aging | aged | (kg) | aging | aged | (kg) | aging |
| Al₂O₃, 3 mm | 5.25 | 1.42 | −3.83 | 9.67 | 13 | 3.33 | 10.83 |
| Borosilicate | 4.89 | 1 | −3.89 | 5.92 | 15 | 9.08 | 15 |
| ball, 3 mm | | | | | | | |

As demonstrated in Table 8, the scratch resistance for Sample 5 increased with aging. Meanwhile, the scratch resistance of the raw glass decreased with aging. In addition, the scratch resistance of Sample 5 was similar to or even greater than the DLC coated glass.

Additionally, FIG. 6 shows the thermogravimetric analysis (black) and differential thermal analysis (grey) curves at increasing temperatures. Accordingly, as can be seen, rapid weight loss is observed around 50-100° C. , which is likely attributed to evaporation of the organic solvent. The peak around 250° C. is likely attributed to the formation of crystals and the prior and subsequent water evaporation.

### Example 3

The samples in the following example were prepared by coating a glass substrate with a sol by spin coating.

The samples were prepared according to the formulations in Table 9 below. In particular, respective amounts of the sols were provided in an 80 mL glass bottle. The sols were mixed by stirring for 10 minutes before using. The solution was filtered using a PE microfiltration film with a pore size of 2. 7 microns. The filtered solution was observed to be transparent without any precipitation.

TABLE 9

| | | Sample 6 | Sample 7 | Sample 8 |
|---|---|---|---|---|
| | Oxides in sol | (482-15-1) | (482-15-2) | (482-15-3) |
| Sol VI | Si, Al, Ti, Cu | 6 | 6 | 4 |
| (476-188-1) | | | | |
| (mL) | | | | |
| Sol VII | Zn, Al | 6 | 8 | 8 |
| (476-182-4) | | | | |
| (mL) | | | | |

The sols were prepared according to the formulations in the tables below:

TABLE 10

| | | Sample 9 | Sample 10 | Sample 11 | Sample 12 |
|---|---|---|---|---|---|
| | Oxides in sol | (476-188-5) | (476-188-6) | (476-188-7) | (476-188-8) |
| Sol VI | Si, Al, Ti, Cu | 2 | 2 | 0 | 0 |
| (476-188-1) | | | | | |
| (mL) | | | | | |
| Sol VIII | Si, Al, Ti, Cu | 0 | 0 | 1.5 | 1 |
| (476-188-2) | | | | | |
| (mL) | | | | | |
| Sol VII | Zn, Al | 1 | 0.7 | 2 | 2 |
| (476-182-4) | | | | | |
| (mL) | | | | | |

TABLE 11

| | | Sol VI | Sol VIII |
|---|---|---|---|
| | | (476-188-1) | (476-188-2) |
| ID | Oxide | (mL) | (mL) |
| Sol IX | SiO₂ | 0.2 | 0.2 |
| (482-74-1 ) | | | |
| Sol X | TiO₂ | 4 | 4 |
| (456-29-2) | | | |
| Sol XI | CuO | 4 | 0 |
| (476-183-3) | | | |
| Sol XII | CuO | 0 | 4 |
| (476-183-5) | | | |
| Sol XIII | Al₂O₃ | 0.4 | 0.4 |
| (456-100-2) | | | |
| NPA | — | 4 | 4 |

TABLE 12

| | Sol VII |
|---|---|
| | (476-182-4) |
| Chem., | (g) |
| Zn acetate | 1.5 |
| Ethanolamine | 0.8 |
| NPA | 26 |
| Acetic acid | 0.3 |
| Aluminum nitrate 9H₂O | 0.3 |
| H₂O | 0.3 |

For Sol VIII in the table below, the components were added to a 100 mL glass jar with the acetic acid being added after initial mixing of the other components. The solution was stirred at room temperature for 24 hours. Silicon dioxide nanoparticles with hydroxyl groups could be developed during the aging process.

For Sol X in the table below, the components were added to a 70 mL glass jar and the titanium isopropoxide was added last, after adding the HNO₃. The solution was stirred at room temperature for 24 hours. The transparent solution was kept in the dark and at room temperature. Titanium dioxide nanoparticles with hydroxyl groups could be developed during the aging process.

For Sols XI and XII in the table below, the components were added to a 70 mL glass jar. The solution was stirred at room temperature for 24 hours. The transparent solution was kept in the dark and at room temperature. Copper oxide nanoparticles with hydroxyl groups could be developed during the aging process.

For Sol XIII in the table below, the components were added to a 70 mL glass jar. The solution was stirred at room temperature for 24 hours. The transparent solution was kept in the dark and at room temperature. Aluminum oxide nanoparticles with hydroxyl groups could be developed during the aging process.

TABLE 13

| | Sol IX | Sol X | Sol XI | Sol XII | Sol XIII |
|---|---|---|---|---|---|
| | (482-74-1) | (456-29-2) | (476-183-3) | (476-183-5) | (456-100-2) |
| | (g) | (g) | (g) | (g) | (g) |
| Titanium | — | 2 | — | — | — |
| isopropoxide | | | | | |
| Aluminum | — | — | — | — | 2 |
| s-butoxide | | | | | |
| Tetraethyl | 10 | — | — | — | — |
| orthosilicate | | | | | |
| Copper | — | — | 0.8 | 1 | — |
| acetate | | | | | |
| NPA | 28.8 | 18 | 13 | 13 | 24 |
| Acetic acid | 2.02 | 0.1 | — | — | — |
| Deionized | 0.75 | 0.1 | 13 | 13 | — |
| water | | | | | |
| HNO₃ (70%) | — | 1 | 2.4 | 3.4 | 2 |

Table 14 provides the solid percent of the sol solutions. This was obtained by heating the sols at 200° C. for 20 minutes. To measure the solid percent, 10 mL of solution was added in an aluminum pan which was set inside a burner. After 20 minutes, the solid percent was recorded.

TABLE 14
Solids Percent

| ID | Oxides in sol | Solvent wt. % | Solid wt. % |
|---|---|---|---|
| Sol X | TiO₂ | 96.71 | 3.29 |
| (456-29-2) | | | |
| Sol IX | SiO₂ | 96.8 | 3.2 |
| (482-74-1 ) | | | |
| Sol XIII | Al₂O₃ | 96.91 | 3.09 |
| (456-100-2) | | | |
| Sol XI | CuO | 93.92 | 6.08 |
| (476-183-3) | | | |
| Sol VI | SiO₂/Al₂O₃/ | 98.41 | 1.59 |
| (476-188-1) | TiO₂/CuO | | |
| Sol VII | ZnO/Al₂O₃ | N/A | N/A |
| (476-182-4) | | | |
| Sample 8 | SiO₂/Al₂O₃/ | 96.63 | 3.37 |
| (482-15-3) | TiO₂/CuO/ZnO/Al₂O₃ | | |

The refractive indices of certain samples were then measured as a function of the thickness of the sample. The results are illustrated in FIG. 3. As illustrated, the final thickness of the coating may have little impact on the refractive index. The corresponding data is provided below in Table 15.

TABLE 15

| Speed, rpm | Thickness, nm | Refractive index, at 550 nm |
|---|---|---|
| 800 | 26.1 | 1.82 |
| 1400 | 19.66 | 1.82 |
| 2000 | 16.38 | 1.87 |
| 2500 | 16.37 | 1.85 |

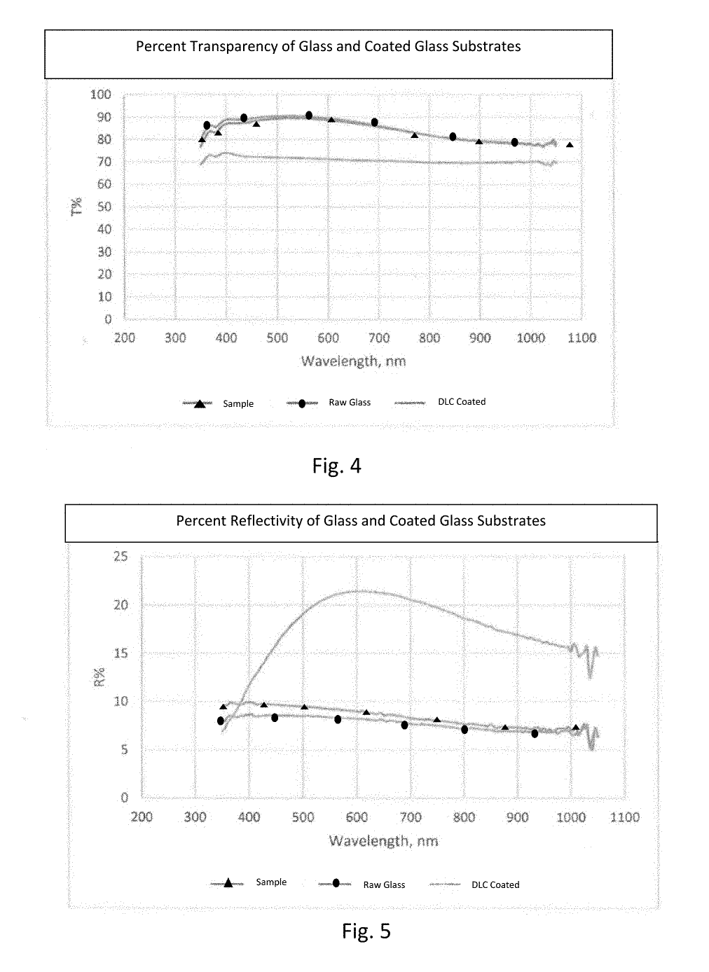

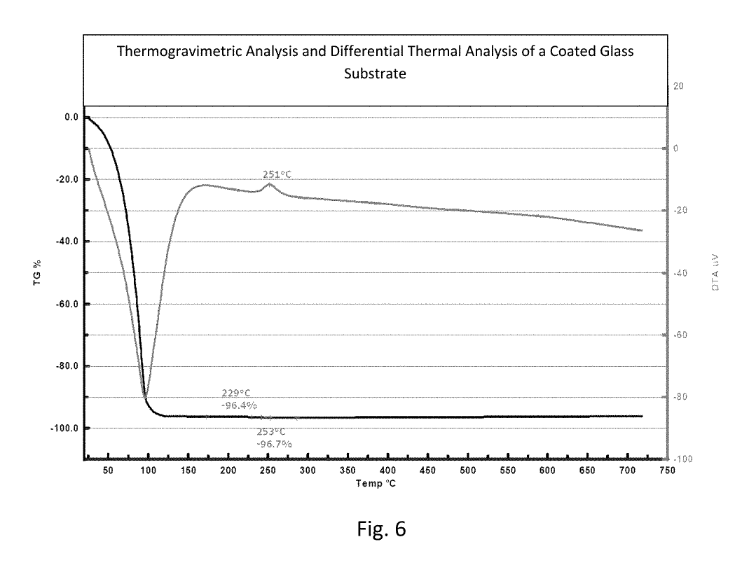

Additionally, FIG. 4 provides a comparison of the transparency of raw glass, DLC coated glass, and the sample of Table 9. Meanwhile, FIG. 5 provides a comparison of the reflectivity of raw glass, DLC coated glass, and the sample of Table 9. As can be seen, the transparency and the reflectivity of the sample of Table 9 are similar to the transparency and reflectivity of raw/uncoated glass and better than that of the DLC coated glass.

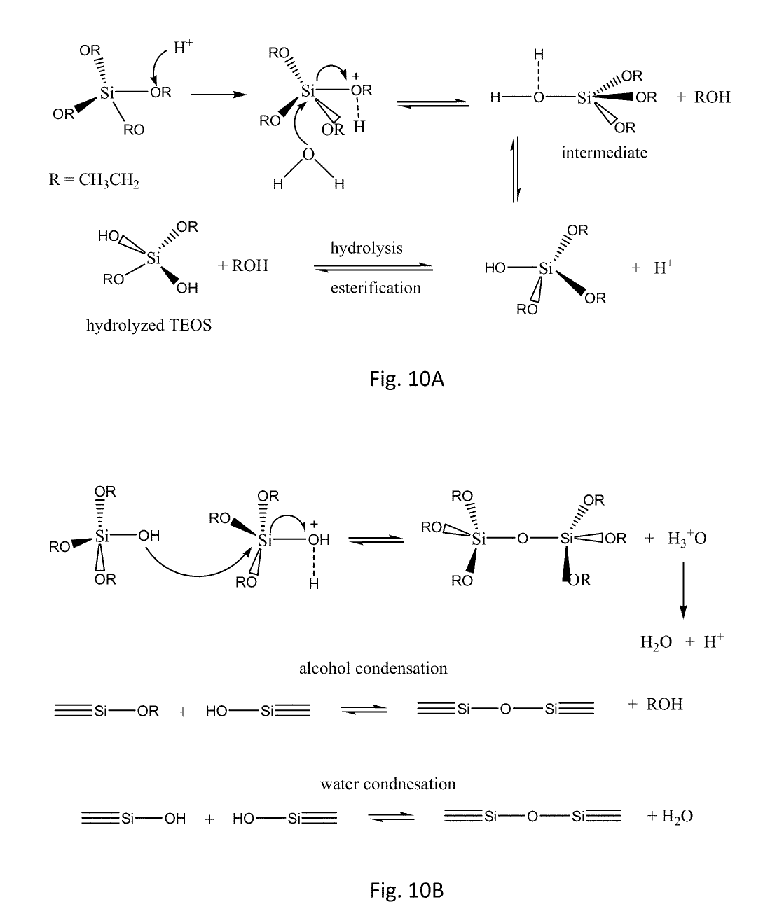

Further, FIGS. 9A and 9B illustrate the effect of aging the coating prior to tempering. For the antiwear performance, a 10 mm aluminum oxide ball with a 1 kg force was moved on the surface of the glass. As can be seen in FIG. 9A, the wear cycle number increases after aging. For the antiscratch performance, a 3 mm aluminum oxide ball with a force of from 1 kg to 15 kg was utilized. Similarly, in FIG. 9B, the CSL is increased after aging. The data presented in these figures is an average of six measurements.

In addition, Table 16 below provides a comparison of the optical, antiwear, and antiscratch performance of the sample, raw glass, and DLC coated glass.

TABLE 16

| | | | | CSL | Cycle |
|---|---|---|---|---|---|
| | T % | R % | H % | (kg) | number |
| DLC coated | 71.59 | 23.04 | 0.64 | 5.83 | 202 |
| glass | | | | | |
| Raw glass | 90.04 | 8.26 | 0.11 | 0 | 0 |
| Sample 8 | 88.92 | 9.45 | 0.20 | 15 | 113 |
| aged for 14 | | | | | |
| days | | | | | |

As demonstrated in Table 16, the coating from the sample exhibited better optical properties than DLC coated glass and similar properties to raw glass. In addition, the antiscratch performance of the coated glass of the sample is much higher than that of the DLC coated glass.

Also, surface roughness measurements were obtained for Sample 8. The results are provided in the following table. As can be seen in the results, a smooth surface can be obtained.

TABLE 17

| Speed, rpm | Rq, nm | Ra, nm |
|---|---|---|
| 800 | 4.85 | 3.60 |
| 1400 | 3.66 | 2.51 |
| 2000 | 4.40 | 3.27 |

Water contact angle measurements were also obtained. The water contact angle was measured to be an average of 60. 58° with a standard deviation of 2. 15°. This was based on three measurements. A hydrophilic surface was observed, which can be attributed to the oxides on the surface and which can wet water relatively quickly.

In addition to the above, other measurements were also obtained for Sample 8. These results are provided in Table 18 below.

TABLE 18

| | Sample 8 |
|---|---|
| Test item | (482-15-3) |
| Cross-hatch | 5B |
| Crocker meter, 750 cycles | 1 |
| Stud pull, psi | 1636 |
| Scratch length, SL, mm | 7.33 |
| Critical scratch loading, CSL, kg | 9.5 |
| Tape pull | pass |
| Brush Test, 3000 cycles | 1 |

Chemical resistance of Sample 8 was determined. These results are provided in Table 19 below. The data is the average of three measurements. As indicated by the data, there is almost no change in T% and CSL when samples were tested with mineral oil. With NaOH, there is a change that is much lower in comparison to the sample tested with HCL. Some decrease in CSL could be attributed to an attack of the base solution on the coating layer.

TABLE 19

| | | | | | post | | Post |
|---|---|---|---|---|---|---|---|
| | | | | | CSL, | ΔCSL, | crock |
| Test item | Method | ΔE | ΔC | ΔT % | kg | kg | hatch |
| NaOH (10%, | TP301-C, | 0.02 | 0.01 | 0.05 | 4.13 | −3.75 | 5B |
| 24 hours, | 1 hours | | | | | | |
| r.t) | | | | | | | |
| HCl (5%, | TP301-C, | 0.38 | 0.24 | 0.71 | 0 | −7.88 | 5B |
| 24 hours, | 1 hours | | | | | | |
| r.t) | | | | | | | |
| Mineral oil | TP301-16C, | 0.04 | 0.03 | 0.07 | 8.63 | 0.075 | 5B |
| (24 hours, | 24 hours | | | | | | |
| r.t) | | | | | | | |

The effect of the coating speed on the performance of the glass was also determined. These results are provided in Table 20 below. As indicated, there is minimal change on the haze of the coated glass. However, T% decreased slightly when speed increased. As a result, R% increased when spin speed decreased due to a thinner coating layer. Meanwhile, a smoother coating surface could also be achieved with a higher speed. Also, there was minimal impact on the antiscratch performance of the coating layer when the spin speed changed. Also, statistically, the spin speed has minimal effect on the CSL and thus on the scratch resistance.

TABLE 20

| Speed, rpm | T % | STD | R % | STD | H % | STD | SL, mm | STD | CSL, kg | STD |
|---|---|---|---|---|---|---|---|---|---|---|
| 800 | 88.57 | 0.14 | 9.59 | 0.18 | 0.22 | 0.03 | 9.22 | 6.26 | 8.08 | 4.7 |
| 1400 | 88.88 | 0.04 | 9.45 | 0.02 | 0.2 | 0.02 | 7.33 | 3.91 | 9.5 | 2.93 |
| 2000 | 88.98 | 0.09 | 9.33 | 0.04 | 0.2 | 0.02 | 9.78 | 5.52 | 7.67 | 4.14 |

Also, brush tests were performed on Samples 9-12. These results are provided in Table 21 below. As indicated by the results, there was no damage on the surface after 3000 cycles of brush testing.

TABLE 21

| Brush test | | | | |
|---|---|---|---|---|
| (cycle) | Sample 9 | Sample 10 | Sample 11 | Sample 12 |
| TP-208 | (476-188-5) | (476-188-6) | (476-188-7) | (476-188-8) |
| 500 | 1 | 1 | 1 | 1 |
| 1000 | 1 | 1 | 1 | 1 |
| 2000 | 1 | 1 | 1 | 1 |
| 3000 | 1 | 1 | 1 | 1 |

The antimicrobial performance was also determined. These results are summarized in Table 22. The data presented is the average of three different measurements. The glass shows excellent antimicrobial performance when evaluated by both E. coli and S. aureus as indicated by the log reduction (LR). A log reduction of 2. 8 corresponds to a 99. 99% reduction after testing.

TABLE 22

| ID | Zn in sol., wt. % | LR vs E. Coli | LR vs S. Aureus |
|---|---|---|---|
| Control raw | 0 | 0 | 0.6 |
| glass 4 mm | | | |
| Sample 6 | 0.009 | 4.6 | 3.1 |
| (482-15-1) | | | |
| Sample 7 | 0.010 | 4.6 | 3.1 |
| (482-15-2) | | | |
| Sample 8 | 0.012 | 4.6 | 2.8 |
| (482-15-3) | | | |

### Example 4

The samples in the following example were prepared by coating a glass substrate with a sol listed in Table 23 by spin coating.

TABLE 23

| | ID | | | | | |
|---|---|---|---|---|---|---|
| | Sample 13 | | Sample 14 | | Sample 15 | |
| | (460-81-3-1) | | (460-81-3-2) | | (460-81-3-3) | |
| | wt. | wt. | wt. | wt. | wt. | wt. |
| Chem. | (g) | % | (g) | % | (g) | % |
| Titanium isopropoxide | 0.70 | 2.78 | 0.70 | 2.78 | 0.70 | 2.78 |
| Zirconium n-propoxide | 0.35 | 1.39 | 0.35 | 1.39 | 0.35 | 1.39 |
| Aluminum s-butoxide | 0.07 | 0.28 | 0.07 | 0.28 | 0.07 | 0.28 |
| Copper acetate | 0.53 | 2.09 | 0.53 | 2.09 | 0.53 | 2.09 |
| Tetraethyl | 0.24 | 0.95 | 0.15 | 0.59 | 0.05 | 0.20 |
| orthosilicate | | | | | | |
| (TEOS) | | | | | | |
| Nano silicate | 1.31 | 5.21 | 0.82 | 3.23 | 0.28 | 1.12 |
| (IPA-ST-UP) | | | | | | |
| Acetic acid | 0.39 | 1.55 | 0.39 | 1.55 | 0.39 | 1.55 |
| HNO₃ (70%) | 1.61 | 6.40 | 1.61 | 6.40 | 1.61 | 6.40 |
| NPA | 15.60 | 61.89 | 16.19 | 64.23 | 16.82 | 66.73 |
| De-ion water | 4.40 | 17.45 | 4.40 | 17.45 | 4.40 | 17.45 |
| Total | 25.21 | 100.00 | 25.21 | 100.00 | 25.21 | 100.00 |

The sols were prepared by adding the components listed in Table 23 into a 100 mL glass bottle. Then, the components were stirred at room temperature for 24 hours before using.

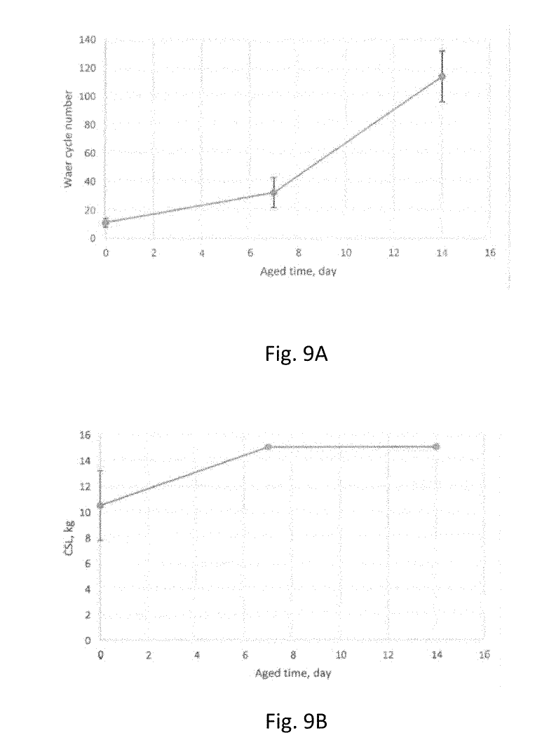

The transparency and reflectivity of each sample was measured. As can be seen in FIGS. 8A and 8B, the transparency and reflectivity of the samples in comparison to uncoated glass is substantially similar at higher wavelengths. For instance, there is some loss on transparency and reflectivity at relatively lower wavelengths, e. g. , from 350 nm to 500 nm.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1-30. (canceled)

31. A coated glass substrate comprising
a glass substrate;
a coating containing a hybrid network comprising at least two oxides;
wherein the coating exhibits a coefficient of friction of less than 0. 12 when measured according to ASTM D7027; and
wherein the coating exhibits a critical scratch load of at least about 10 kg as measured according to ASTM test C1624-05.

32. The coated glass substrate according to claim 31, wherein the oxides are formed from an alkoxide having the following formula:
M^{x+}(OR)⁻ₓ
wherein,
x is from 1 to 4;
R is an alkyl or cycloalkyl; and
M is a metal or non-metal cation.

33. The coated glass substrate of claim 32, wherein M comprises copper, aluminum, zinc, zirconium, silicon or titanium.

34. The coated glass substrate of claim 31, wherein the hybrid network comprises at least three oxides.

35. The coated glass substrate of claim 31, wherein the oxides of the hybrid network include at least three of silicon, titanium, zirconium, aluminum, copper, and zinc.

36. The coated glass substrate of claim 31, wherein the oxides of the hybrid network include at least four of silicon, titanium, zirconium, aluminum, copper, and zinc.

37. The coated glass substrate of claim 31, wherein the coating contains less than about 5 wt. % carbon or carbon based compounds.

38. The coated glass substrate of claim 31, wherein the coating exhibits a percent transparency of about 75% or greater.

39. The coated glass substrate of claim 31, wherein the coating exhibits a percent reflectivity of less than about 12%.

40. The coated glass substrate of claim 31, wherein the coating has a thickness of about 15 nm to about 50 nm.

41. A method for making a coated glass substrate comprising:
coating a glass substrate with a coating composition comprising a solvent and a plurality of hydrolyzed compounds,
heating the coating and the substrate to form a hybrid network comprising at least two oxides;
wherein the coating exhibits a coefficient of friction of less than 0. 12 when measured according to ASTM D7027; and
wherein the coating exhibits a critical scratch load of at least about 10 kg as measured according to ASTM test C1624-05.

42. The method of claim 41, wherein the hydrolyzed compound is a hydrolyzed alkoxide formed from an alkoxide having the following formula:
M^{x+}(OR)⁻ₓ
wherein,
x is from 1 to 4;
R is an alkyl or cycloalkyl; and
M is a metal or non-metal cation.

43. The method of claim 42, wherein M comprises copper, aluminum, zinc, zirconium, silicon or titanium.

44. The method of claim 41, wherein the hybrid network includes at least three oxides.

45. The method of claim 41, wherein the oxides of the hybrid network include at least three of silicon, titanium, zirconium, aluminum, copper, and zinc.

46. The method of claim 41, wherein the oxides of the hybrid network include at least four of silicon, titanium, zirconium, aluminum, copper, and zinc.

47. The method of claim 41, wherein the hydrolyzed compound is a hydrolyzed metal acetate formed from a metal acetate.

48. The method of claim 47, wherein the metal acetate comprises zinc acetate, copper acetate, or a combination thereof.

49. The method of claim 41, wherein the heating is conducted at a temperature of at least about 500° C.

50. The method of claim 41, further comprising aging the coating and the glass substrate before the heating step.

51. The method of claim 50, wherein the aging step comprises aging the coating for a period of at least about six days.

52. The method of claim 41, wherein the coating composition is applied to the substrate by a spin coating process.

53. The method of claim 41, wherein the coating is formed by a sol-gel process.
